(19) United States
(12) Patent Application Publication
(10) Pub. No.: US 2015/0196959 A1
(43) Pub. Date: Jul. 16, 2015

(54) CUTTING TOOL WITH WEDGE CLAMPING SYSTEM

(71) Applicant: Kennametal Inc., Latrobe, PA (US)

(72) Inventors: Michael Glenn Morrison, Tarrs, PA (US); Jeffrey Francis Kovac, Loyalhanna, PA (US)

(73) Assignee: Kennametal Inc., Latrobe, PA (US)

(21) Appl. No.: 14/154,231

(22) Filed: Jan. 14, 2014

(51) Int. Cl. B23B 27/16

(52) U.S. Cl. CPC B23B 27/1666; B23B 2205/16

(57) ABSTRACT

A cutting tool includes a pocket with a top wall, a bottom wall, a side wall and a rear wall. The cutting tool has a wedge clamping system that includes an insert cartridge and a clamp wedge. The insert cartridge includes a recess that interacts with a protrusion on the clamp wedge in such a way that the clamp wedge exerts a force vector in an axial direction when the clamp wedge is threaded into the pocket, thereby reducing deflection of an adjacent pocket of the cutting tool when the cutting tool is placed in a locked condition.

### BACKGROUND OF THE INVENTION

1. Field of the Invention

The invention pertains to the field of cutting tools. More particularly, the invention pertains to a cutting tool with a wedge clamping system that resists centrifugal forces to securely hold a cutting insert in the pocket of the cutting tool during a cutting operation.

2. Description of Related Art

Conventional cutting tools with insert cartridges use various means for mounting the insert cartridges to the tool body. One known method of clamping an insert cartridge in a pocket of a cutting tool is by means of a clamp wedge. Unfortunately, the insert cartridge has a tendency to fly out of the pocket at higher cutting speeds due to centrifugal forces, thereby increasing cycle times and associated costs.

### SUMMARY OF THE INVENTION

The problem of securely clamping an insert cartridge in a pocket of a cutting tool is solved by providing a cutting tool with a wedge clamping system that resists centrifugal forces to securely hold a cutting insert in the pocket of the cutting tool during a cutting operation.

In one aspect of the invention, a cutting tool comprises a cutting tool comprises a pocket including a top wall, a bottom wall, a side wall and a rear wall; and a wedge clamping system comprising an insert cartridge and a clamp wedge. The insert cartridge includes a recess for interacting with a protrusion on the clamp wedge in such a way that the clamp wedge exerts a force vector in an axial direction when the clamp wedge is threaded into the pocket, thereby reducing deflection of an adjacent pocket of the cutting tool when the cutting tool is placed in a locked condition.

In another aspect of the invention, a cutting tool comprises a pocket including a top wall, a bottom wall, a side wall and a rear wall (24); an insert cartridge comprising a top wall, a bottom wall opposite the top wall, a pair of opposing side walls extending between the top and bottom walls, and an insert pocket formed in the top wall of the insert cartridge at an intersection between the front wall of the insert cartridge and one of the side walls of the insert cartridge (14) for receiving a cutting insert; and a clamp wedge comprising a top wall, a bottom wall opposite the top wall, a front wall, a rear wall opposite the front wall, and a pair of opposing side walls extending between the top and bottom walls, wherein the insert cartridge includes a recess for interacting with a protrusion on the clamp wedge in such a way that the clamp wedge exerts a force vector in an axial direction when the clamp wedge is threaded into the pocket, thereby reducing deflection of an adjacent pocket of the cutting tool when the cutting tool is placed in a locked condition.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a side view of a cutting tool with a wedge clamping system in accordance with an embodiment of the invention;

FIG. 2 is an isometric top view of an insert cartridge according to an embodiment of the invention;

FIG. 3 is an isometric top view of a clamp wedge according to an embodiment of the invention;

FIG. 4 is an isometric bottom view of the clamp wedge of FIG. 3;

FIG. 5 is an isometric view of the insert cartridge and clamp wedge when mounted in the pocket in a locked condition; and

FIG. 6 is a side view of the insert cartridge and clamp wedge when mounted in the pocket in a locked condition.

### DETAILED DESCRIPTION OF THE INVENTION

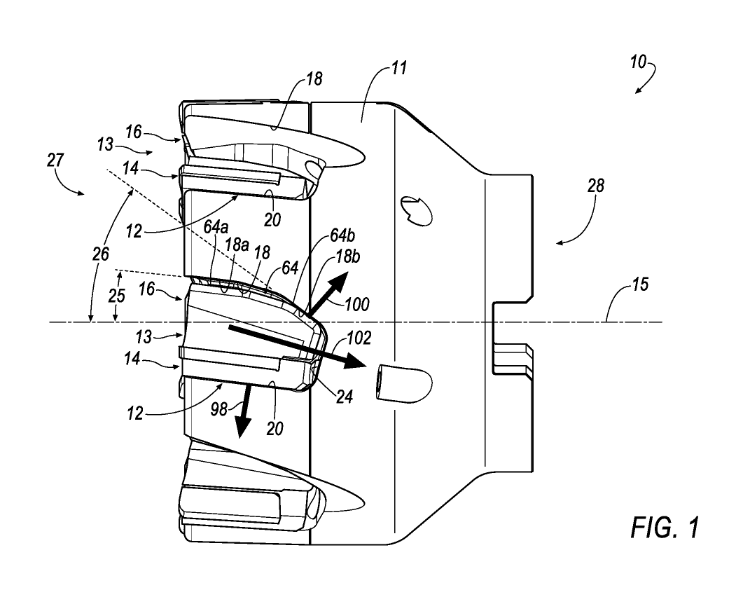

Referring now to FIG. 1, a cutting tool 10, for example, a milling cutter, includes a body 11 with a pocket 12 and a wedge clamping system, shown generally at 13, according to an embodiment of the invention. It will be appreciated that the cutting tool 10 may include any number of pockets 12, and that the invention is not limited by the number of pockets 12 shown in the illustrated embodiment. Each pocket 12 is capable of receiving an insert cartridge 14 and a clamp wedge 16, shown generally in FIG. 1, respectively. The insert cartridge 14 and the clamp wedge 16 comprises the wedge clamping system 13 of the invention.

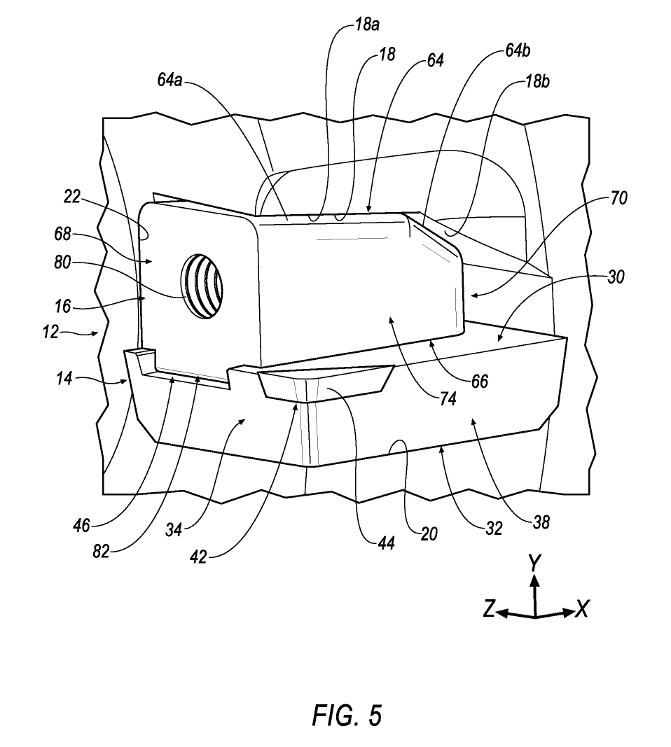

In general, the pocket 12 includes a top wall 18, a bottom wall 20, a side wall 22 (FIG. 5) for engaging the insert cartridge 14 and a rear wall 24. The rear wall 24 acts as a stop for the insert cartridge 14 when the insert cartridge 14 is mounted in the pocket 12 in a locked condition. The top wall 18 has a first portion 18a formed at a first angle 25 with respect to a central, longitudinal axis 15 of the cutting tool 10, and a second portion 18b formed at a second angle 26 with respect to the central, longitudinal axis 15, wherein the second angle 26 is greater than the first angle 25. The first portion 18a is closer to a cutting end 27 of the cutting tool 10 than the second portion 18b. In other words, the second portion 18b is closer to a mounting end 28 of the cutting tool 10 than the first portion 18a.

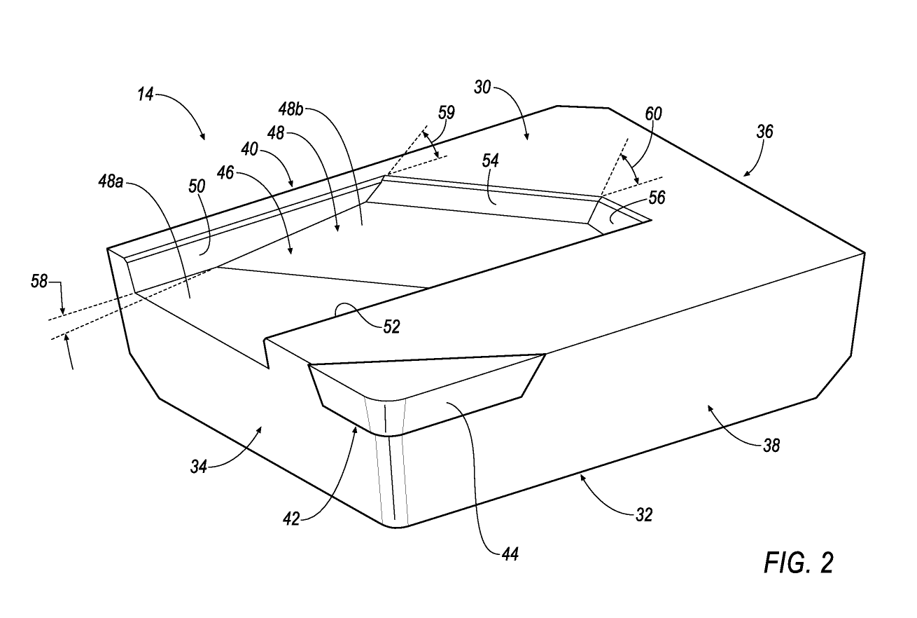

Referring now to FIG. 2, the insert cartridge 14 is shown according to an embodiment of the invention. The insert cartridge 14 is generally rectangular in shape having a top wall 30, a bottom wall 32 opposite the top wall 30, a front wall 34, a rear wall 36 opposite the front wall 34, and a pair of opposing side walls 38, 40 extending between the top and bottom walls 30, 32. In general, the top wall 30, the bottom wall 32, the front wall 34, the rear wall 36 and the side walls 38, 40 are substantially planar. An insert pocket 42 is formed in the top wall 30 at an intersection between the front wall 34 and one of the side walls 38, 40 for receiving a blade or cutting insert 44. In the illustrated embodiment, the insert pocket 42 is formed in the top wall 30 between the front wall 34 and the side wall 38. The cutting insert 44 can be mounted in the insert pocket 42 using any well-known means in the art, such as brazing, and the like.

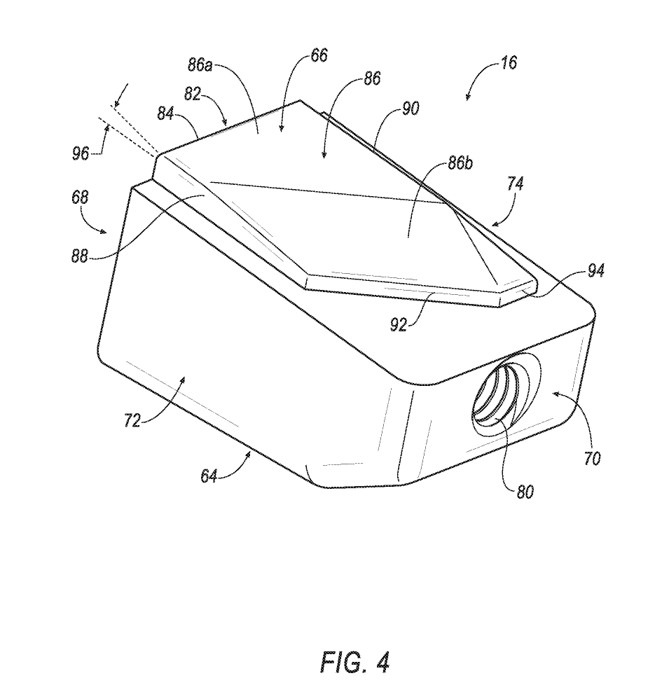

In general, the top wall 30, the bottom wall 32, the front wall 34 and the rear wall 36 are substantially perpendicular to the side walls 38, 40. In one aspect of the invention, a recess, shown generally at 46, is formed in the top wall 30 for accommodating a protrusion 82 (FIG. 4) of the clamp wedge 16, thereby acting as a seating surface for the clamp wedge 16 to resist the insert cartridge 14 from sliding out of the pocket 12 during a cutting operation. The recess 46 also reduces the overall weight of the insert cartridge 14, thereby reducing the centrifugal forces experienced by the cutting tool 10 during a cutting operation. When the insert cartridge 14 and the clamp wedge 16 are in the locked condition, the bottom wall 32 engages the bottom wall 20 of the pocket 12.

In the illustrated embodiment, the recess 46 extends from the front wall 34 toward the rear wall 36, but does not extend entirely to the rear wall 36. Also, the recess 46 does not extend entirely to the side walls 38, 40, but is located inward therefrom. The recess 46 includes a bottom wall 48, a pair of opposing side walls 50, 52, a first rear wall 54 and a second rear wall 56. The bottom wall 48 includes a first portion 48a that is formed substantially perpendicular to the front wall 34, and a second portion 48b formed at an angle 58 greater than zero (0) degrees with respect to the first portion 48a. In other words, the second portion 48b of the bottom wall 48 is not formed perpendicular to the front wall 34. In one embodiment, for example, the angle 58 can be between about one (1) degree and about ten (10) degrees. In addition, the first rear wall 54 is formed at an angle 59 greater than zero (0) degrees and less than ninety (90) degrees with respect to the first portion 48a and the second portion 48b of the bottom wall 48 of the recess 46. Similarly, the second rear wall 54 is formed at an angle 60 greater than zero (0) degrees and less than ninety (90) degrees with respect to the first portion 48a and the second portion 48b of the bottom wall 48 of the recess 46. The angles 59, 60 can be equal to each other, or the angles 59, 60 can be different from each other.

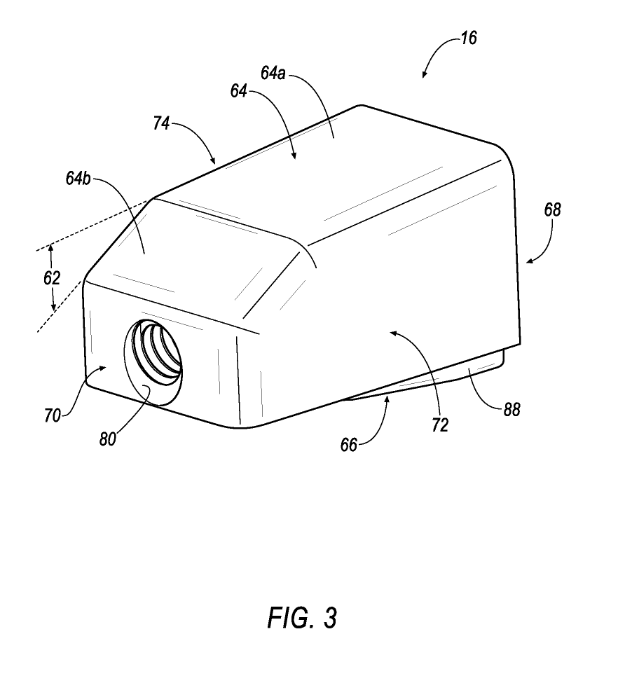

Referring now to FIGS. 3 and 4, the clamp wedge 16 is shown according to an embodiment of the invention. The clamp wedge 16 is generally rectangular in shape having a top wall 64, a bottom wall 66 opposite the top wall 64, a front wall 68, a rear wall 70 opposite the front wall 70, and a pair of opposing side walls 72, 74 extending between the top and bottom walls 64, 66. In general, the top wall 64, the bottom wall 66, the rear wall 70 and the side walls 72, 74 are substantially planar. The top wall 64 includes a first portion 64a that extends from the front wall 68 toward the rear wall 70, and a second portion 64b that extends from the rear wall 70 toward the front wall 68.

In general, the top wall 64, the bottom wall 66, the front wall 68 and the rear wall 70 are substantially perpendicular to the side walls 72, 74. In another aspect of the invention, the second portion 64b is formed at an angle 62 greater than zero (0) degrees and less than ninety (90) degrees with respect to with respect to the first portion 64a. In other words, the second portion 64b of the top wall 64 is not perpendicular with respect to the front and rear walls 68, 70 such that a thickness of the clamp wedge 16 is largest proximate the front wall 68 and smallest proximate the rear wall 70. When the insert cartridge 14 and the clamp wedge 16 are in the locked condition, the top wall 64 of the clamp wedge 16 engages the top wall 18 of the pocket 12. Specifically, the first portion 64a of the top wall 64 of the clamp wedge 16 is designed to not make contact with the first portion 18a of the top wall 18 of the pocket 12, and the second portion 64b of the top wall 64 of the clamp wedge 16 engages the second portion 18b of the top wall 18 of the pocket 12. The clamp wedge 16 also includes a threaded bore 80 extending from the front wall 68 through the rear wall 70 to allow a wedge screw (not shown) to be threaded into the threaded bore 80 to draw the clamp wedge 16 into the pocket 12.

In another aspect of the invention, the bottom wall 66 of the clamp wedge 16 includes a protrusion 82 that is accommodated in the recess 46 of the insert cartridge 14. In general, the protrusion 82 is generally the same shape as the recess 46. In the illustrated embodiment, the protrusion 82 extends from the front wall 68 toward the rear wall 70, but does not extend entirely to the rear wall 70. Also, the protrusion 82 does not extend entirely to the side walls 72, 74, but is located inward therefrom. The protrusion 82 includes a front wall 84, a top wall 86, a pair of opposing side walls 88, 90, a first rear wall 92 and a second rear wall 94. The top wall 86 includes a first portion 86a that is formed substantially perpendicular to the front wall 84, and a second portion 86b formed at an angle 96 greater than zero (0) degrees with respect to the first portion 86a. In other words, the second portion 86b of the top wall 86 is not formed perpendicular to the front wall 84. In one embodiment, for example, the angle 96 can be between about one (1) degree and about ten (10) degrees. In one embodiment, the angle 96 is approximately equal to the angle 58 between the first portion 48a and the second portion 48b of the bottom wall 48 of the recess 46. In another embodiment, the angle 96 is different than the angle 58.

It should be noted that the first rear wall 92 is formed substantially perpendicular (i.e. at an angle of about ninety (90) degrees) with respect to the first portion 86a, unlike the first rear wall 54 of the recess 46. Similarly, the second rear wall 94 is formed substantially perpendicular (i.e. at an angle of about ninety (90) degrees) with respect to the first portion 86a, unlike the second rear wall 56 of the recess 46.

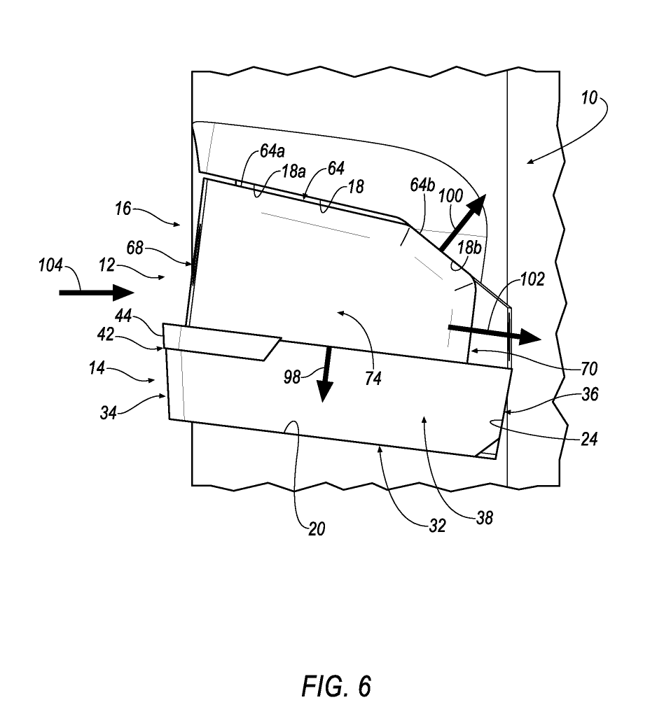

FIGS. 5 and 6 show the insert cartridge 14 and the clamp wedge 16 mounted in the pocket 12 of the cutting tool 10 in a locked condition. As shown in FIGS. 5 and 6, the clamp wedge 16 moves rearward with respect to the insert cartridge 14 as the clamp screw (not shown) is threaded into the threaded bore 80. As a result of this relative movement between the insert cartridge 14 and the clamp wedge 16, the second portion 86b of the clamp wedge 16 comes into contact with the second portion 48b of the insert cartridge 14 causing the clamp wedge 16 to exert a force in an axial direction 104 (i.e., in a direction along the x-axis) against the insert cartridge 14, thereby causing the insert cartridge 14 to be securely held in the pocket 12 during operation.

FIGS. 1 and 6 shows force vectors 98, 100, 102 in the axial direction (along the x-axis) due to the clamping forces when the insert cartridge 14 and the clamp wedge 16 are in the locked condition. Specifically, the force vector 98 is due to the interaction between the top wall 18 of the pocket 12 and the top wall 64 of the clamp wedge 16, and the force vector 100 is due to the interaction between the recess 46 of the insert cartridge 14 and the protrusion 82 of the clamp wedge 16. The force vector 102 is due to the threading of the clamp screw (not shown) into the threaded bore 82 of the clamp wedge 16. The force vectors 98, 100 are due to the clamping force exerted by the clamp wedge 16 on the insert cartridge 14. It is also noted that the force vector 98 is in a direction that is substantially perpendicular to the axial direction 104, while the force vector 100 is directed in the axial direction 104 (i.e. in the direction of the x-axis), thereby reducing deflection of the adjacent pocket 12 of the cutting tool 10. It is also noted that the force vector 102 ensures full face seating between the insert cartridge 14 and the clamp wedge 16. In addition, the force vector 102 is not parallel to the axial direction 104, thereby reducing tensile stress on the clamp screw (not shown) during a cutting operation.

As described above, the cutting tool 10 of the invention with the wedge clamping system 13 causes the clamp wedge 16 to press against the top wall 18 and the insert cartridge 14 to press against the bottom wall 20 of the pocket 12 to securely hold the insert cartridge 14 in place when in the locked condition during a cutting operation.

The patents and publications referred to herein are hereby incorporated by reference.

Having described presently preferred embodiments the invention may be otherwise embodied within the scope of the appended claims.

What is claimed is:

1. A cutting tool comprising:
a pocket including a top wall, a bottom wall, a side wall and a rear wall; and
a wedge clamping system comprising an insert cartridge and a clamp wedge, the insert cartridge including a recess for interacting with a protrusion on the clamp wedge in such a way that the clamp wedge exerts a force vector in an axial direction when the clamp wedge is threaded into the pocket, thereby reducing deflection of an adjacent pocket of the cutting tool when the cutting tool is placed in a locked condition.

2. The cutting tool according to claim 1, wherein the insert cartridge comprises a top wall, a bottom wall opposite the top wall, a front wall, a rear wall opposite the front wall, a pair of opposing side walls extending between the top and bottom walls, and an insert pocket formed in the top wall of the insert cartridge at an intersection between the front wall of the insert cartridge and one of the side walls of the insert cartridge for receiving a cutting insert.

3. The cutting tool according to claim 2, wherein the recess is formed in the top wall of the insert cartridge, the recess having a bottom wall with a first portion and a second portion.

4. The cutting tool according to claim 3, wherein the second portion is formed at an angle greater than zero degrees with respect to the first portion.

5. The cutting tool according to claim 3, wherein the recess further includes a first rear wall and a second rear wall, wherein at least one of the first and second rear walls is formed at an angle greater than zero degrees and less than ninety degrees with respect to the first portion and the second portion of the bottom wall of the recess.

6. The cutting tool according to claim 1, wherein the clamp wedge includes a top wall, a bottom wall opposite the top wall, a front wall, a rear wall opposite the front wall, and a pair of opposing side walls extending between the top and bottom walls.

7. The cutting tool according to claim 7, wherein the protrusion is formed on the bottom wall of the clamp wedge, the protrusion having a top wall with a first portion and a second portion.

8. The cutting tool according to claim 7, wherein the second portion is formed at an angle greater than zero degrees with respect to the first portion.

9. The cutting tool according to claim 6, wherein the top wall of the clamp wedge interacts with the top wall of the pocket such that the clamp wedge exerts a force vector in a direction substantially perpendicular to an axial direction of the cutting tool.

10. The cutting tool according to claim 1, wherein the rear wall acts as a stop for the insert cartridge when the insert cartridge is mounted in the pocket in a locked condition.

11. A cutting tool comprising:
a pocket including a top wall, a bottom wall, a side wall and a rear wall;
an insert cartridge comprising:
a top wall, a bottom wall opposite the top wall, a pair of opposing side walls extending between the top and bottom walls, and an insert pocket formed in the top wall of the insert cartridge at an intersection between the front wall of the insert cartridge and one of the side walls of the insert cartridge for receiving a cutting insert; and
a clamp wedge comprising:
a top wall, a bottom wall opposite the top wall, a front wall, a rear wall opposite the front wall, and a pair of opposing side walls extending between the top and bottom walls,
wherein the insert cartridge includes a recess that interacts with a protrusion on the clamp wedge in such a way that the clamp wedge exerts a force vector in an axial direction when the clamp wedge is threaded into the pocket, thereby reducing deflection of an adjacent pocket of the cutting tool when the cutting tool is placed in a locked condition.

12. The cutting tool according to claim 11, wherein the recess is formed in the top wall of the insert cartridge, the recess having a bottom wall with a first portion and a second portion.

13. The cutting tool according to claim 12, wherein the second portion is formed at an angle greater than zero degrees with respect to the first portion.

14. The cutting tool according to claim 12, wherein the recess further includes a first rear wall and a second rear wall, wherein at least one of the first and second rear walls is formed at an angle greater than zero degrees and less than ninety degrees with respect to the first portion and the second portion of the bottom wall of the recess.

15. The cutting tool according to claim 11, wherein the protrusion is formed on the bottom wall of the clamp wedge, the protrusion having a top wall with a first portion and a second portion.

16. The cutting tool according to claim 15, wherein the second portion is formed at an angle greater than zero degrees with respect to the first portion.

17. The cutting tool according to claim 11, wherein the top wall of the clamp wedge interacts with the top wall of the pocket such that the clamp wedge exerts a force vector in a direction substantially perpendicular to an axial direction of the cutting tool.
